(19) United States
(12) Patent Application Publication
(10) Pub. No.: US 2002/0131763 A1
(43) Pub. Date: Sep. 19, 2002

(54) Video processing and/or recording

(76) Inventor: Morgan William Amos David, Farnham (GB)

Correspondence Address: William S. Frommer, Esq., FROMMER LAWRENCE & HAUG LLP, 745 Fifth Avenue, New York, NY, 10151, US

(21) Appl. No.: 10/014,148

(22) Filed: Dec. 4, 2001

Related U.S. Application Data
(63) Continuation of application No. PCT/GB01/01480, filed on Mar. 30, 2001.

(30) Foreign Application Priority Data
Apr. 5, 2000 (GB) 0008410.3
Apr. 5, 2000 (GB) 0008407.9

(51) Int. Cl. H04N 5/783

(52) U.S. Cl. 386/69; 386/96; 386/124

(57) ABSTRACT

A tape medium has recorded thereon successive slant tracks, each comprising a number of sectors, in which, across a group of one or more slant tracks:

at least one independently writeable sector stores primarily video material;

at least one independently writeable sector stores primarily audio material; and at least one independently writeable sector stores metadata associated with the audio and/or video material, the metadata including at least a material identifier and other data relating to the material.

This invention relates to video processing and/or recording.

Several formats of digital video tape have been proposed. The first commercially successful format was the so-called “D1” format, described in the book, “Introduction to the 4:2:2 Digital Video Tape Recorder”, Gregory, Pentech Press, 1988 [1]. Since then there have been many other formats, either standardised or proprietary.

A feature that these formats have in common is the use of helical scanning. This is a well-established technique in which the tape medium is wrapped at least part of the way around a head drum. One or more rotating read/write heads, mounted on the head drum, sweep out successive slant tracks on the tape medium as the medium is progressed slowly past the head drum.. Slant tracks may carry a timecode known in some systems as Vertical Interval Timecode (VITC). Linear tracks may also be used to carry information such as Linear Timecode (LTC), other control information, a cueing audio track and the like.

Each slant track is generally divided up into a number of regions or sectors. Although the precise number and layout of these regions varies from format to format, there are generally one or more video sectors and one or more audio sectors on each slant track. These can store compressed or uncompressed video and audio data. In other systems, data representing each video frame or image, or a group of images, may be recorded onto a group of tracks.

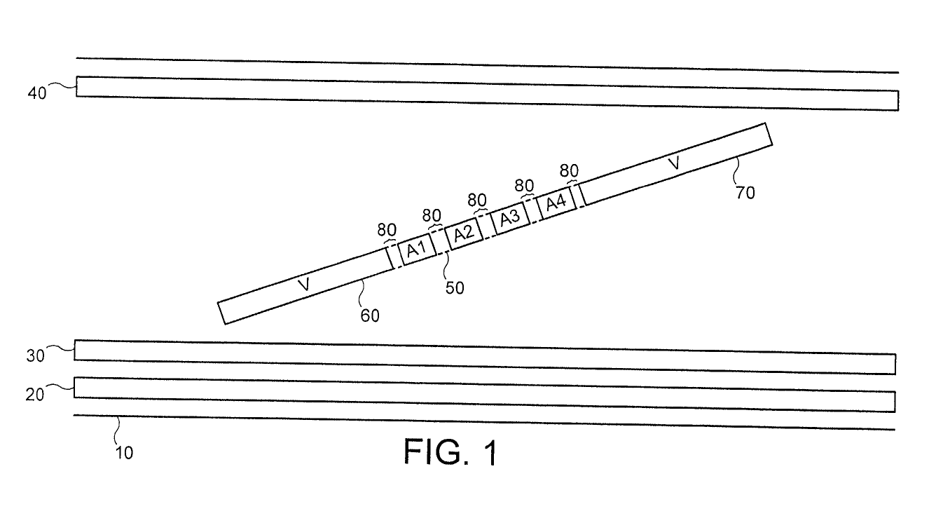

An example of a tape format is shown schematically in FIG. 1 of the accompanying drawings. On the tape 10 there are three linear tracks disposed towards the tape edges: a linear time code track 20, a control track 30 and a cue audio track 40. Each slant track 50 has a predetermined layout of data sectors: two video sectors 60, 70 and four audio sectors A1..A4, each separated by a small gap 80 in the head scanning direction. The audio sectors A1..A4 correspond to four audio recording tracks or channels.

Recently, interest has developed in ways of recording so-called metadata along with the audio and video material. Metadata is additional or accompanying data defining the audio/video material in some fashion, and can include data items such as material identifiers (e.g. the SMPTE Unique Material Identifier or UMID), bibliographic data such as cast or staff lists, copyright information, equipment used and so on. Of course, if any such metadata is to be stored alongside the audio/video material on tape, some data capacity needs to be allocated for its storage.

This invention provides a digital video tape recorder operable to record successive slant tracks, each comprising a number of sectors, on a tape medium, in which, across a group of one or more slant tracks:

at least one independently writeable sector stores primarily video material;

at least one independently writeable sector stores primarily audio material; and

at least one independently writeable sector stores metadata associated with the audio and/or video material, the metadata including at least a material identifier and other data relating to the material.

The invention provides a technique for storing metadata along with the audio/video material on tape which allows a potentially large data capacity and the potential ability to modify the metadata later. Modification of the metadata at a later stage is important because extra details may need to be added or some details (such as copyright ownership) may indeed change if the programme is sold or licensed to other parties.

The invention provides a dedicated sector or sectors—perhaps one or more per slant track or one or more in a group of slant tracks—to store metadata. This allows more flexibility in allocating data capacity to the metadata and also, because the sector is separate, the ability to read, write or modify the metadata sectors independently of the audio/video material.

It is considered counter-intuitive to add a further sector for the following reason. The sectors have a small gap 80 between them in the head scanning direction. The gap length corresponds to the distance moved by the heads during the time taken to switch the record current on or off, plus a margin of safety. This is important to allow independent later modification of the content of a sector without affecting the content of neighbouring or other sectors on the same slant track. The gaps 80 are kept to the minimum possible length to avoid wasting tape capacity—wherever there is a gap, data cannot be stored. So, the addition of another sector for metadata means an additional gap as well as a loss of some data capacity for the helical scanning tracks. However, the invention involves the realisation that this perceived disadvantage actually leads to the advantageous ability to modify the metadata later independently of the audio/video content.

In preferred embodiments, each slant track recorded by the recorder comprises:

at least one independently writeable sector stores primarily video material;

at least one independently writeable sector stores primarily audio material; and

at least one independently writeable sector stores metadata associated with the audio and/or video material, the metadata including at least a material identifier and other data relating to the material.

In one embodiment, the independently writeable sector(s) storing metadata have a predetermined data capacity per slant track. This has the advantage that the start and end positions of the metadata sector(s) can be predetermined, allowing location or modification of the metadata to be made in a straightforward manner.

In another embodiment, the recorder is operable to vary the extent of the metadata sector(s) in response to the amount of metadata associated with each time segment (e.g. a field or frame) of the video and/or audio material. This avoids wasting tape capacity on empty or poorly filled metadata sectors, and can be achieved by, for example, varying the degree of quantisation of the video data in a compressed system.

In order to facilitate the location by the recorder of the metadata sector(s), it is preferred that the recorder comprises means for recording control data onto the tape indicating the extent of the metadata sector(s) of at least each slant track carrying one or more metadata sectors. Preferably the control data is recorded at a position on the tape so that, in a normal replay direction, the control data relating to a slant track is recovered from the tape before the head traverses a metadata sector of that slant track. This allows the control data defining the position of the metadata sector(s) to be obtained before the head even reaches those sector(s).

Preferably the recorder is arranged to record four concurrent audio channels on the tape medium.

This invention also provides a video recorder operable to record video and audio material together with a timecode having a plurality of user-definable data bits;

the video recorder being operable to store a material identifying code in a subset of the user-definable bits of the timecode so that each instance of the material identifying code extends over the timecode user bits corresponding to an ordered sequence of more than one frame of the video material, the recorder also recording in a further subset of the user-definable bits of the timecode for each frame a sequence position indicator, indicative of the position of the current frame in the ordered sequence.

In this aspect the invention recognises that previous attempts to store metadata along with the audio/video material, for example on tape, have suffered from the limitation that the timecode user bits do not provide sufficient data capacity to store the whole of, say, an SMPTE extended UMID, particularly when existing uses of the user bits such as GSMs are taken into account.

Accordingly, the material identifying code is split over several frames, and a position indicator is included so that the position of a current frame's TC user bits in the sequence can be established.

This can be particularly useful in the case of a standard format material identifying code such as an SMPTE UMID, in which the order of information items within the UMID is predetermined. Accordingly, if replay starts part way through the sequence, useful data can potentially still be extracted even before the next complete instance of the UMID is recovered.

Although the invention is suited to other recording media such as disk media, it is preferred that the recorder is a tape recorder operable to record video and audio material in successive slant tracks and at least one linear track on a tape medium, the linear track storing a linear track timecode having a plurality of user-definable data bits. In this case, it is particularly convenient if the material identifying code and the sequence position indicator are stored in respective subsets of the user-definable bits of the linear track timecode.

It is preferred that the material identifying code is a code which uniquely defines the material amongst other material items stored on the same medium. In particular preferred embodiments the material identifying code is an SMPTE UMID.

Further respective aspects and features of the invention are defined in the appended claims.

Embodiments of the invention will now be described with reference to the accompanying drawings, throughout which like parts are referred to by like references, and in which:

FIG. 1 is a schematic diagram illustrating a previously proposed tape format;

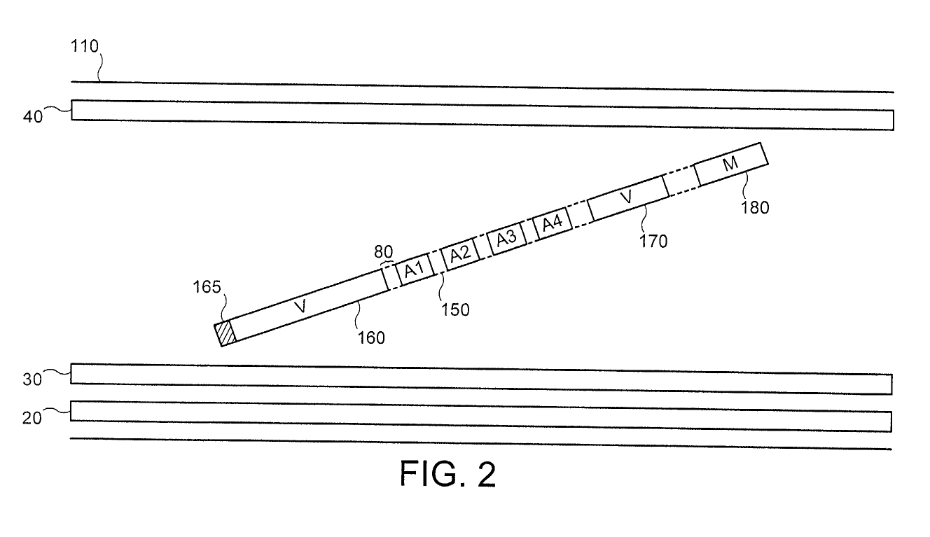

FIG. 2 is a schematic diagram schematically illustrating a tape format according to an embodiment of the invention;

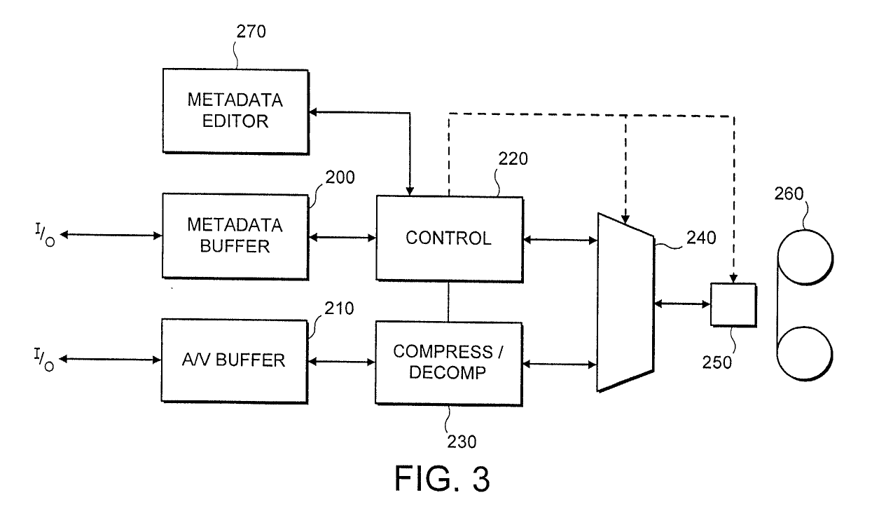

FIG. 3 schematically illustrates a tape recording/replay apparatus according to an embodiment of the invention;

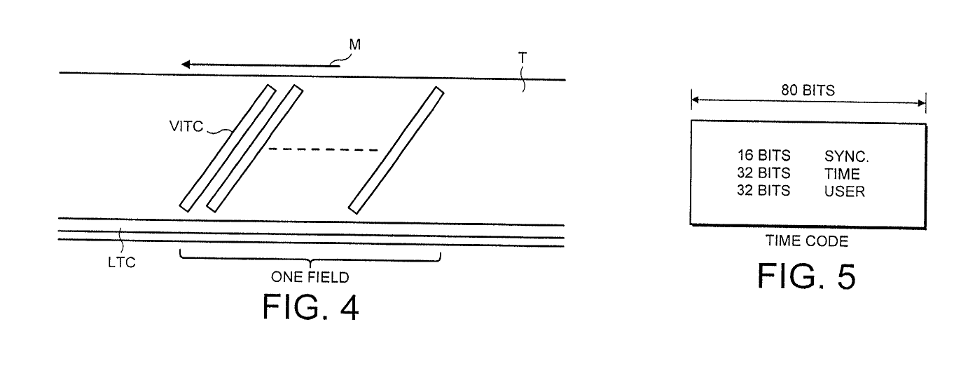

FIG. 4 schematically illustrates the representation of time code data in a known tape format;

FIG. 5 schematically illustrates a time code;

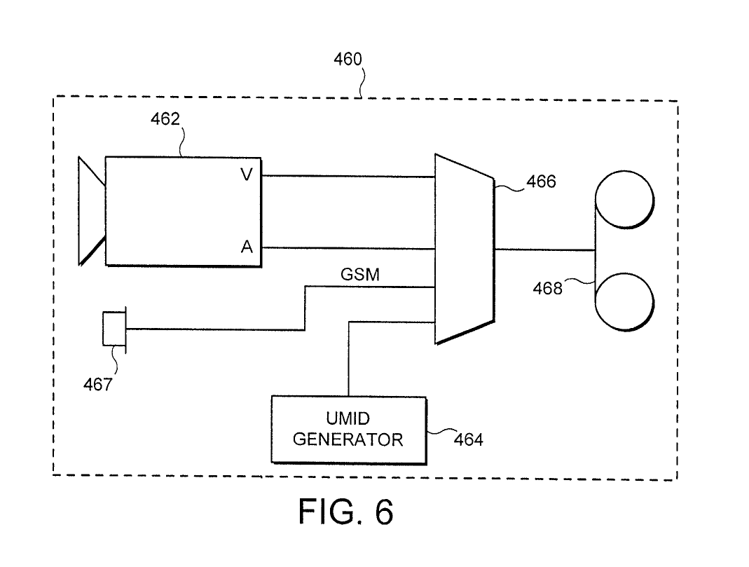

FIG. 6 schematically illustrates a digital camcorder;

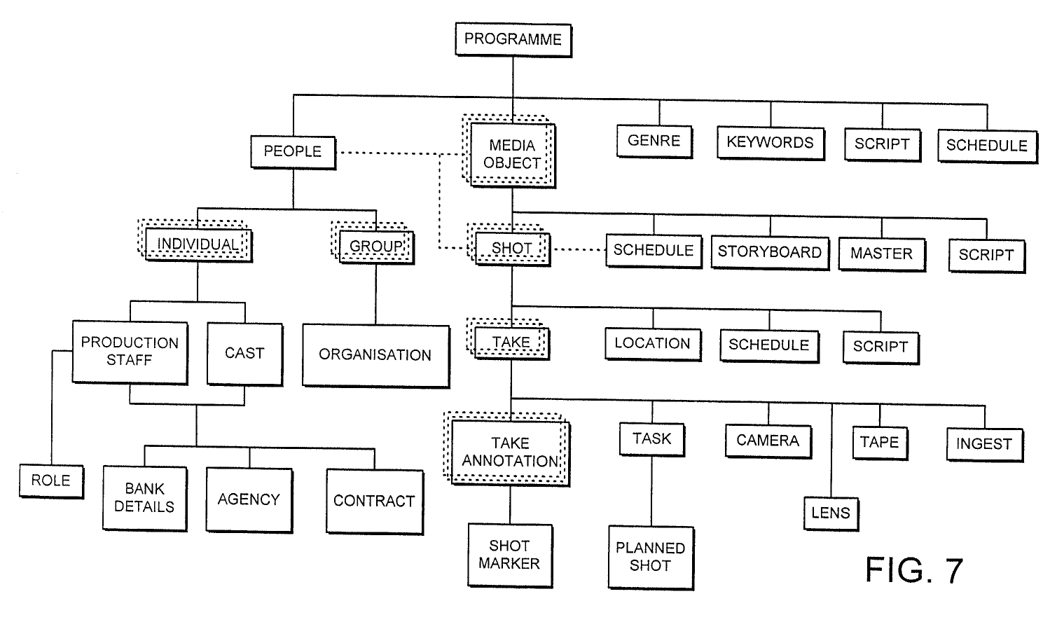

FIG. 7 schematically illustrates a metadata structure; and

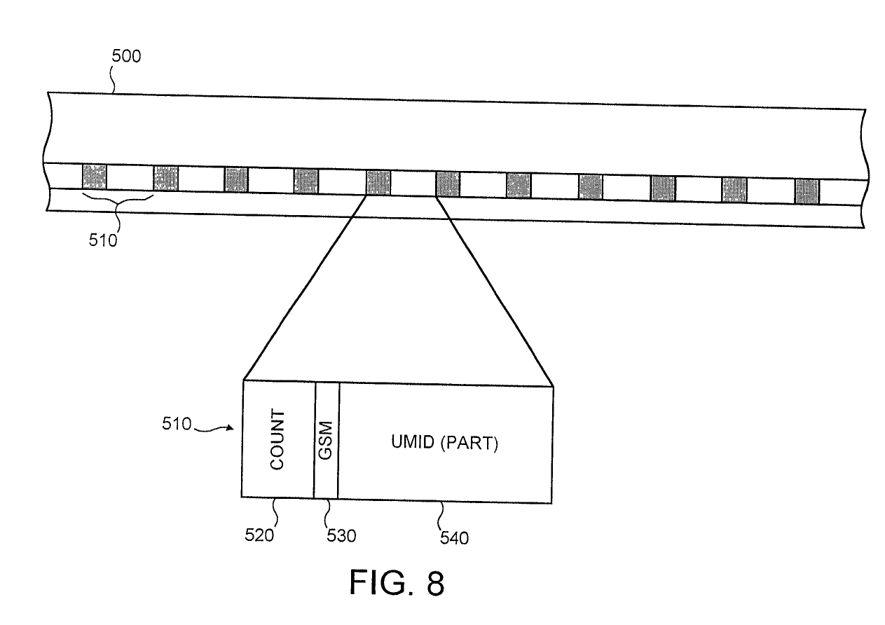

FIG. 8 schematically illustrates the recording of material-identifying metadata onto a video time code.

Referring now to FIG. 2, a tape medium 110 carries linear tracks 20, 30, 40 as before, along with successive slant tracks 150 having independently writeable sectors separated by gaps 80 in the head scanning direction.

In this example embodiment the sectors are as follows: a video sector 160 (optionally having header data 165—see below), audio sectors A1..A4 representing four concurrent audio channels, a further video sector 170 and a metadata sector 180 storing at least the SMPTE UMID and other metadata such as production information, cast lists, copyright ownership, bibliographic data and the like.

The boundary between the sectors 170 and 180, that is to say (indirectly) their data capacities, can be predetermined for that tape format. However, in embodiments of the invention the boundary can be moveable in dependence on the amount of metadata to be stored, so that the available tape capacity is not wasted if the quantity of metadata is low.

In the case of a moveable boundary, data defining the boundary, or defining the size of some sectors so that the boundary position can be derived, could be stored in for example the metadata sector of a preceding track. Alternatively, it could be stored in the same track to which it refers, but further towards the start of the track in a head scanning direction. The header 165 could be used for this information in relation to the boundary between the sectors 170 and 180. In either of these example cases, in a normal replay direction the head traverses the relevant area defining the boundary position before it reaches the boundary itself. This allows the metadata sector to be located and, if desired, modified independently of the video and audio sectors.

FIG. 3 schematically illustrates a tape recording/replay apparatus operable to write, read and/or edit tapes recorded to the tape format shown in FIG. 2.

The apparatus of FIG. 3 comprises a metadata buffer, an audio/video buffer 210, a control circuit 220, a compression/decompression device 230, a multiplexer 240, a tape recording/replay arrangement having a recording/replay head set 250 and a tape medium 260, and a metadata editor 270.

Recording onto Tape

Audio/video material is received and buffered in the AN buffer 210, and metadata associated with the A/V material is buffered in the metadata buffer. The control circuit 220 detects the quantity of metadata—on a field-by-field basis, a frame-by-frame basis or as averaged over a particular number of fields or frames. In response to this detection, the control circuit controls the compression ratio or a compression parameter such as quantisation of the compression/decompression device 230 to compress the A/V data so as to allow space for the metadata. A lower limit on the amount of A/V data to be recorded can be set, in order to maintain quality. An example of a system in which the degree of compression is varied in response to the amount of metadata is given in GB9927111.6, a copy of which is placed on the file of the present application as a background document.

The metadata and compressed A/V data are passed to the multiplexer/demultiplexer 240 to be formatted into a data stream for recording on respective sectors of the tape medium 260. The control circuit 220 also controls the tape recording arrangement so that sector gaps 80 occur at the correct positions to record the respective amounts of metadata and A/V data.

Replay from Tape

Data replayed form the tape is passed to the multiplexer/demultiplexer 240 which separates metadata from A/V data. If control data defining the boundary between metadata and other sectors is recorded elsewhere (e.g. in the header 165) this can be separated off and passed to the control circuit 220. Otherwise, the control circuit could recover this information from the metadata sector of a preceding track, or wherever it had been stored.

The metadata is output via the metadata buffer. The A/V data is decompressed by the compression/decompression device and output via the A/V buffer.

Editing Metadata

If it is desired to edit only the metadata, then the metadata can be read from the tape, passed to a metadata editor (e.g. a computer terminal or apparatus running appropriate editing software) and then re-recorded back onto the tape as described above.

If a variable boundary arrangement is not used, so that the metadata sector has a fixed size and boundaries, then the arrangement of FIG. 3 may be simplified in that the control circuit does not need to control the degree of compression of the compression/decompression device.

Of course, it is not necessary to have one metadata sector per track. Other embodiments could use more than one, or perhaps metadata sector(s) on only some tracks, for example in a repetitive fashion across a group of tracks.

Referring to FIG. 4, a tape format is shown schematically. Video and audio information is recorded in helical tracks of which a set of, e.g. 10 or 12, tracks records one field of video. The helical tracks include vertical interval time codes (VITC). The time codes may be duplicated in a linear time code track LTC, but the contents of the VITC and LTC may be different. The tape may comprise at least one other linear track (not shown). In this illustrative description it is assumed that all video, audio and other information is recorded digitally. However, the video and audio may be recorded as analogue information. The video and audio information may be compressed according to the MPEG 2 standard for example.

The time codes are recorded once per video field. As schematically shown in FIG. 5, a known time code has 80 bits of which 16 are reserved for synchronisation information, 32 for time code bits and 32 for user defined bits, herein referred to as “user bits”. The user bits are interleaved with the other bits in a typical time code; however the invention is not limited to that.

Tape IDs and UMIDs

SMPTE UMIDs are material identifiers which are universally unique. In embodiments of the present invention they are used to bind material i.e. video and/or audio recorded on the tape to metadata which is stored in for example a database 464 as shown in FIG. 6.

A UMID is described in reference [2]. An extended UMID comprises a first set of 32 bytes of basic UMID and a second set of 32 bytes of signature metadata.

The first set of 32 bytes is the basic UMID. The components are:

A 12-byte Universal Label to identify this as a SMPTE UMID. It defines the type of material which the UMID identifies and also defines the methods by which the globally unique Material and locally unique Instance numbers are created.

A 1-byte length value to define the length of the remaining part of the UMID.

A 3-byte Instance number which is used to distinguish between different ‘instances’ of material with the same Material number.

A 16-byte Material number which is used to identify each clip. Each Material number is the same for related instances of the same material.

The second set of 32 bytes of the signature metadata as a set of packed metadata items used to create an extended UMID. The extended UMID comprises the basic UMID followed immediately by signature metadata which comprises:

An 8-byte time/date code identifying the time and date of the Content Unit creation.

A 12-byte value which defines the spatial co-ordinates at the time of Content Unit creation.

3 groups of 4-byte codes which register the country, organisation and user codes

Each component of the basic and extended UMIDs will now be defined in turn.

The 12-byte Universal Label

The first 12 bytes of the UMID provide identification of the UMID by the registered string value defined in table 1.

TABLE 1
Specification of the UMID Universal Label

| Byte No. | Description | Value (hex) |
|---|---|---|
| 1 | Object Identifier | 06h |
| 2 | Label size | 0Ch |
| 3 | Designation: ISO | 2Bh |
| 4 | Designation: SMPTE | 34h |
| 5 | Registry: Dictionaries | 01h |
| 6 | Registry: Metadata Dictionaries | 01h |
| 7 | Standard: Dictionary Number | 01h |
| 8 | Version number | 01h |
| 9 | Class: Identification and location | 01h |
| 10 | Sub-class: Globally Unique Identifiers | 01h |
| 11 | Type: UMID (Picture, Audio, Data, Group) | 01, 02, 03, 04h |
| 12 | Type: Number creation method | XXh |

The hex values in table 1 may be changed: the values given are examples. Also the bytes 1-12 may have designations other than those shown by way of example in the table. Referring to the Table 1, in the example shown byte 4 indicates that bytes 5-12 relate to a data format agreed by SMPTE. Byte 5 indicates that bytes 6 to 10 relate to “dictionary” data. Byte 6 indicates that such data is “metadata” defined by bytes 7 to 10. Byte 7 indicates the part of the dictionary containing metadata defined by bytes 9 and 10. Byte 10 indicates the version of the dictionary. Byte 9 indicates the class of data and Byte 10 indicates a particular item in the class.

In the present embodiment bytes 1 to 10 have fixed preassigned values. Byte 11 is variable. Thus referring to FIG. 8, and to Table 1 above, it will be noted that the bytes 1 to 10 of the label of the UMID are fixed. Therefore they may be replaced by a 1 byte ‘Type’ code T representing the bytes 1 to 10. The type code T is followed by a length code L. That is followed by 2 bytes, one of which is byte 11 of Table 1 and the other of which is byte 12 of Table 1, an instance number (3 bytes) and a material number (16 bytes). Optionally the material number may be followed by the signature metadata of the extended UMID and/or other metadata.

The UMID type (byte 11) has 4 separate values to identify each of 4 different data types as follows:

‘01h’=UMID for Picture material

‘02h’=UMID for Audio material

‘03h’=UMID for Data material

‘04h’=UMID for Group material (i.e. a combination of related essence).

The last (12th) byte of the 12 byte label identifies the methods by which the material and instance numbers are created. This byte is divided into top and bottom nibbles where the top nibble defines the method of Material number creation and the bottom nibble defines the method of Instance number creation.

Length

The Length is a 1-byte number with the value ‘13h’ for basic UMIDs and ‘33h’ for extended UMIDs.

Instance Number

The Instance number is a unique 3-byte number which is created by one of several means defined by the standard. It provides the link between a particular ‘instance’ of a clip and externally associated metadata. Without this instance number, all material could be linked to any instance of the material and its associated metadata.

The creation of a new clip requires the creation of a new Material number together with a zero Instance number. Therefore, a non-zero Instance number indicates that the associated clip is not the source material. An Instance number is primarily used to identify associated metadata related to any particular instance of a clip.

Material Number

The 16-byte Material number is a non-zero number created by one of several means identified in the standard. The number is dependent on a 6-byte registered port ID number, time and a random number generator.

Signature Metadata

Any component from the signature metadata may be null-filled where no meaningful value can be entered. Any null-filled component is wholly null-filled to clearly indicate a downstream decoder that the component is not valid.

The Time-Date Format

The date-time format is 8 bytes where the first 4 bytes are a UTC (Universal Time Code) based time component. The time is defined either by an AES3 32-bit audio sample clock or SMPTE 12M depending on the essence type.

The second 4 bytes define the date based on the Modified Julian Data (MJD) as defined in SMPTE 309M. This counts up to 999,999 days after midnight on the Nov. 17, 1858 and allows dates to the year 4597.

The Spatial Co-ordinate Format

The spatial co-ordinate value consists of three components defined as follows:

Altitude: 8 decimal numbers specifying up to 99,999,999 meters.

Longitude: 8 decimal numbers specifying East/West 180.00000 degrees (5 decimal places active).

Latitude: 8 decimal numbers specifying North/South 90.00000 degrees (5 decimal places active).

The Altitude value is expressed as a value in meters from the centre of the earth thus allowing altitudes below the sea level.

It should be noted that although spatial co-ordinates are static for most clips, this is not true for all cases. Material captured from a moving source such as a camera mounted on a vehicle may show changing spatial co-ordinate values.

Country Code

The Country code is an abbreviated 4-byte alpha-numeric string according to the set defined in ISO 3166. Countries which are not registered can obtain a registered alpha-numeric string from the SMPTE Registration Authority.

Organisation Code

The Organisation code is an abbreviated 4-byte alpha-numeric string registered with SMPTE. Organisation codes have meaning only in relation to their registered Country code so that Organisation codes can have the same value in different countries.

User Code

The User code is a 4-byte alpha-numeric string assigned locally by each organisation and is not globally registered. User codes are defined in relation to their registered Organisation and Country codes so that User codes may have the same value in different organisations and countries.

Freelance Operators

Freelance operators may use their country of domicile for the country code and use the Organisation and User codes concatenated to e.g. an 8 byte code which can be registered with SMPTE. These freelance codes may start with the ‘˜’ symbol (ISO 8859 character number 7Eh) and followed by a registered 7 digit alphanumeric string.

Linking to a Database

It is desirable to provide more detailed metadata relating to the material recorded on the tape. Examples of appropriate metadata are given below. Thus metadata is stored in a database, the UMID linking the metadata to the material.

The following is provided, by way of example, to illustrate the possible types of metadata generated during the production of a programme, and one possible organisational approach to structuring that metadata.

FIG. 7 schematically illustrates an example structure for organising metadata. A number of tables each comprising a number of fields containing metadata are provided. The tables may be associated with each other by way of common fields within the respective tables, thereby providing a relational structure. Also, the structure may comprise a number of instances of the same table to represent multiple instances of the object that the table may represent. The fields may be formatted in a predetermined manner. The size of the fields may also be predetermined. Example sizes include “Int” which represents 2 bytes, “Long Int” which represents 4 bytes and “Double” which represents 8 bytes. Alternatively, the size of the fields may be defined with reference to the number of characters to be held within the field such as, for example, 8, 10, 16, 32, 128, and 255 characters.

Turning to the structure in more detail, there is provided a Programme Table. The Programme Table comprises a number of fields including Programme ID (PID), Title, Working Title, Genre ID, Synopsis, Aspect Ratio, Director ID and Picture stamp. Associated with the Programme Table is a Genre Table, a Keywords Table, a Script Table, a People Table, a Schedule Table and a plurality of Media Object Tables.

The Genre Table comprises a number of fields including Genre ID, which is associated with the Genre ID field of the Programme Table, and Genre Description.

The Keywords Table comprises a number of fields including Programme ID, which is associated with the Programme ID field of the Programme Table, Keyword ID and Keyword.

The Script Table comprises a number of fields including Script ID, Script Name, Script Type, Document Format, Path, Creation Date, Original Author, Version, Last Modified, Modified By, PID associated with Programme ID and Notes. The People Table comprises a number of fields including Image.

The People Table is associated with a number of Individual Tables and a number of Group Tables. Each Individual Table comprises a number of fields including Image. Each Group Table comprises a number of fields including Image. Each Individual Table is associated with either a Production Staff Table or a Cast Table.

The Production Staff Table comprises a number of fields including Production Staff ID, Surname, Firstname, Contract ID, Agent, Agency ID, E-mail, Address, Phone Number, Role ID, Notes, Allergies, DOB, National Insurance Number and Bank ID and Picture Stamp.

The Cast Table comprises a number of fields including Cast ID, Surname, Firstname, Character Name, Contract ID, Agent, Agency ID, Equity Number, E-mail, Address, Phone Number, DOB and Bank ID and Picture Stamp. Associated with the Production Staff Table and Cast Table are a Bank Details Table and an Agency Table.

The Bank Details Table comprises a number of fields including Bank ID, which is associated with the Bank ID field of the Production Staff Table and the Bank ID field of the Cast Table, Sort Code, Account Number and Account Name.

The Agency Table comprises a number of fields including Agency ID, which is associated with the Agency ID field of the Production Staff Table and the Agency ID field of the Cast Table, Name, Address, Phone Number, Web Site and E-mail and a Picture Stamp. Also associated with the Production Staff Table is a Role Table.

The Role Table comprises a number of fields including Role ID, which is associated with the Role ID field of the Production Staff Table, Function and Notes and a Picture Stamp. Each Group Table is associated with an Organisation Table.

The Organisation Table comprises a number fields including Organisation ID, Name, Type, Address, Contract ID, Contact Name, Contact Phone Number and Web Site and a Picture Stamp.

Each Media Object Table comprises a number of fields including Media Object ID, Name, Description, Picture stamp, PID, Format, schedule ID, script ID and Master ID. Associated with each Media Object Table is the People Table, a Master Table, a Schedule Table, a Storyboard Table, a script table and a number of Shot Tables.

The Master Table comprises a number of fields including Master ID, which is associated with the Master ID field of the Media Object Table, Title, Basic UMID, EDL ID, Tape ID and Duration and a Picture Stamp.

The Schedule Table comprises a number of fields including Schedule ID, Schedule Name, Document Format, Path, Creation Date, Original Author, Start Date, End Date, Version, Last Modified, Modified By and Notes and PID which is associated with the programme ID.

The contract table contains: a contract ID which is associated with the contract ID of the Production staff, cast, and organisation tables; commencement date, rate, job title, expiry date and details.

The Storyboard Table comprises a number of fields including Storyboard ID, which is associated with the Storyboard ID of the shot Table, Description, Author, Path and Media ID. Each Shot Table comprises a number of fields including Shot ID, PID, Media ID, Title, Location ID, Notes, Picture stamp, script ID, schedule ID, and description. Associated with each Shot Table is the People Table, the Schedule Table, script table, a Location Table and a number of Take Tables.

The Location Table comprises a number of fields including Location ID, which is associated with the Location ID field of the Shot Table, GPS, Address, Description, Name, Cost Per Hour, Directions, Contact Name, Contact Address and Contact Phone Number and a Picture Stamp.

Each Take Table comprises a number of fields including Basic UMID, Take Number, Shot ID, Media ID, Timecode IN, Timecode OUT, Sign Metadata, Tape ID, Camera ID, Head Hours, Videographer, IN Stamp, OUT Stamp. Lens ID, AUTOID ingest ID and Notes. Associated with each Take Table is a Tape Table, a Task Table, a Camera Table, a lens table, an ingest table and a number of Take Annotation Tables.

The Ingest table contains an Ingest ID which is associated with the Ingest Id in the take table and a description.

The Tape Table comprises a number of fields including Tape ID, which is associated with the Tape ID field of the Take Table, PID, Format, Max Duration, First Usage, Max Erasures, Current Erasure, ETA (estimated time of arrival) and Last Erasure Date and a Picture Stamp.

The Task Table comprises a number of fields including Task ID, PID, Media ID, Shot ID, which are associated with the Media ID and Shot ID fields respectively of the Take Table, Title, Task Notes, Distribution List and CC List. Associated with the Task Table is a Planned Shot Table.

The Planned Shot Table comprises a number of fields including Planned Shot ID, PID, Media ID, Shot ID, which are associated with the PID, Media ID and Shot ID respectively of the Task Table, Director, Shot Title, Location, Notes, Description, Videographer, Due date, Programme title, media title Aspect Ratio and Format.

The Camera Table comprises a number of fields including Camera ID, which is associated with the Camera ID field of the Take Table, Manufacturer, Model, Format, Serial Number, Head Hours, Lens ID, Notes, Contact Name, Contact Address and Contact Phone Number and a Picture Stamp.

The Lens Table comprises a number of fields including Lens ID, which is associated with the Lens ID field of the Take Table, Manufacturer, Model, Serial Number, Contact Name, Contact Address and Contact Phone Number and a Picture Stamp.

Each Take Annotation Table comprises a number of fields including Take Annotation ID, Basic UMID, Timecode, Shutter Speed, Iris, Zoom, Gamma, Shot Marker ID, Filter Wheel, Detail and Gain. Associated with each Take Annotation Table is a Shot Marker Table.

The Shot Marker Table comprises a number of fields including Shot Marker ID, which is associated with the Shot Marker ID of the Take Annotation Table, and Description.

Illustrative System

Referring to FIG. 6, a camcorder 460 comprises a video and audio pickup arrangement 462 (e.g. a CCD image pickup device and a microphone) outputting data audio (A) and video (V) data streams, a UMID generator 464, a multiplexer 466, a good shot marker (GSM) control button 467 and a tape recording arrangement 468.

The UMID generator can take many forms, and serves to generate UMIDs in accordance with the SMPTE standard. In the embodiment to be described, these are 32-byte UMIDs, but other forms of UMID could be generated. The techniques for storing the UMIDs on tape which will be described below are also applicable to material identifying codes other than UMIDs, such as locally unique or even tape-unique reference numbers.

The UMID generator in the present embodiment also has a signal processor (not shown) which may derive metadata from the camera and/or material recorded on the tape and store it or transfer it to an external data store. The UMID generator has a data entry device, for example a keyboard, to enter data and may have, or be connected to, a GPS device for producing (if required) the spatial co-ordinate data of an extended UMID.

Good shot markers are an established feature of many camcorders. A control 467 is provided for the cameraman to operate if he considers that a current shot or take has been successful. A data flag representing a GSM is recorded onto the tape in the time code user bits.

The UMID generated by the UMID generator is passed, with the video and audio data streams and the GSMs, to the multiplexer 466 for recording on the tape.

The multiplexer arranges the UMID data and the GSM flags (and any other such data) into the time code user bits. This could be either the LTC or the VITC or both, although for clarity of the diagram FIG. 8 will refer only to the LTC user bits. These user bits are then passed to the tape transport in a conventional way for recording on the tape.

FIG. 8 schematically illustrates the way in which the multiplexer 466 arranges the UMID and GSM data for recording in the timecode user bits.

At the top of FIG. 8 is a schematic illustration of a tape medium 500 as recorded by the apparatus of FIG. 6, showing successive instances of the LTC user bits 510. One such instance is shown in enlarged form at the bottom of FIG. 8. As mentioned above, the user bits are in fact interspersed with timecode bits, but for clarity of the diagram they are illustrated as a contiguous group.

The user bits contain a counter 520, the GSM data 530 and a part of the UMID 540.

As mentioned above, the maximum capacity of the LTC or VITC user bits in current tape formats is 32 bits per instance (i.e. per field), or 64 bits per frame. Clearly, even the smallest UMID in accordance with the SMPTE standard (32 bytes) will not fit into one or even a pair of instances of the TC user bits.

Accordingly, the multiplexer 466 divides the 32 byte UMID into 16 successive sections of 16 bits each and records them over 16 successive instances of the TC (LTC, VITC or both) user bits, that is, 8 video frames. So, the part UMID 540 shown in FIG. 8 is 16 bits, or half of the TC user bits. The UMID data can be shuffled and/or error corrected as required.

In order to enable a tape replay device to detect where the currently replayed field or frame is in the 16 field or 8 frame sequence used to record a UMID, the multiplexer 466 also provides the counter 520, which occupies no more than 1 byte (8 bits) of the user bits and defines the position within that sequence—for example as a number counting from 0 to 15 (or 0 to 7 for a frame count), then returning to 0 to indicate the start of the next sequence and so on. Clearly, four bits (for a 0 to 15 count) or 3 bits (for a 0 to 7 count) could be used. This leaves at least 8 bits (one byte) to store the GSM or other similar data.

The 32 byte UMID could also be shortened for the present purposes as follows. 12 bytes of the SMPTE UMID are, as described above, the SMPTE label. This includes 10 bytes of substantially static data. In embodiments of the invention, the label is replaced by a short code which can then be mapped back to the UMID label at replay or on later processing. This can shorten the amount of data needed to record the UMID by 10 bytes and allow space for other data such as CRC error correction codes.

Embodiments of the invention also extend to a tape replay device arranged to recover the UMID data by detecting the counter 520 in the TC user bits, and rebuilding the UMID from data recovered from the part UMID sections 540 by assembling those sections in the correct order. Such a device may be substantially as drawn in FIG. 6, but with a demultiplexer performing the above operation in place of the multiplexer 466.

Whilst the embodiments described above each include explicitly recited combinations of features according to different aspects of the present invention, other embodiments are envisaged according to the general teaching of the invention, which include combinations of features as appropriate, other than those explicitly recited in the embodiments described above. Accordingly, it will be appreciated that different combinations of features of the appended independent and dependent claims form further aspects of the invention other than those, which are explicitly recited in the claims.

It will be appreciated that the embodiments of the invention described above may of course be implemented, at least in part, using software-controlled data processing apparatus. For example, one or more of the components schematically illustrated in FIG. 3 and/or FIG. 6 may be implemented as a software-controlled general purpose data processing device or a bespoke program controlled data processing device such as an application specific integrated circuit, a field programmable gate array or the like. It will be appreciated that a computer program providing such software or program control and a storage, transmission or other providing medium, for example, a disk storage medium (not shown) or a network or internet transmission medium, by which such a computer program is provided are envisaged as aspects of the present invention.

### REFERENCES

[1] Introduction to the 4:2:2 Digital Video Tape Recorder—Stephen Gregory Pentech Press 1998, ISBN 0-7273-0903-X

[2] EBU/SMPTE Task Force for Harmonised Standards for the Exchange of Programme Material as Bit Streams, Final Report: Analyses and Results, September 1998.

[3] EBU/IFTA Forum “Paving the Way to Future TV Archives”, Vienna, 18 June 1999, M. F. Vetter, TASC Inc.

[4] MPEG2-ISO/IEC/ 13818-2

1. A digital video tape recorder operable to record successive slant tracks, each comprising a number of sectors, on a tape medium, in which, across a group of one or more slant tracks:
at least one independently writeable sector stores primarily video material;
at least one independently writeable sector stores primarily audio material; and
at least one independently writeable sector stores metadata associated with the audio and/or video material, the metadata including at least a material identifier and other data relating to the material.

2. A recorder according to claim 1, in which each slant track recorded by the recorder comprises:
at least one independently writeable sector stores primarily video material;
at least one independently writeable sector stores primarily audio material; and
at least one independently writeable sector stores metadata associated with the audio and/or video material, the metadata including at least a material identifier and other data relating to the material.

3. A recorder according to claim 1 or claim 2, in which the independently writeable sector(s) storing metadata have a predetermined data capacity per slant track.

4. A recorder according to claim 1 or claim 2, in which the recorder is operable to vary the extent of the metadata sector(s) in response to the amount of metadata associated with each time segment of the video and/or audio material.

5. A recorder according to claim 4, comprising means for recording control data onto the tape indicating the extent of the metadata sector(s) of at least each slant track carrying one or more metadata sectors.

6. A recorder according to claim 5, in which the control data is recorded at a position on the tape so that, in a normal replay direction, the control data relating to a slant track is recovered from the tape before the head traverses a metadata sector of that slant track.

7. A recorder according to any one of the preceding claims, the recorder being arranged to record four concurrent audio channels on the tape medium.

8. A tape format of successive slant tracks, each comprising a number of sectors, in which, across a group of one or more slant tracks:
at least one independently writeable sector stores primarily video material;
at least one independently writeable sector stores primarily audio material; and at least one independently writeable sector stores metadata associated with the audio and/or video material, the metadata including at least a material identifier and other data relating to the material.

9. A tape medium having recorded thereon successive slant tracks, each comprising a number of sectors, in which, across a group of one or more slant tracks:
at least one independently writeable sector stores primarily video material;
at least one independently writeable sector stores primarily audio material; and
at least one independently writeable sector stores metadata associated with the audio and/or video material, the metadata including at least a material identifier and other data relating to the material.

10. An editing apparatus for use with a tape medium according to claim 9, the apparatus comprising means for reading, modifying and rewriting metadata stored in the metadata sector(s) of the slant tracks independently of the audio and video material stored in the audio and video sectors of the slant tracks.

11. A method of recording video material, audio material and associated metadata onto a tape medium, the method comprising the step of recording successive slant tracks, each comprising a number of sectors, in which, across a group of one or more slant tracks:
at least one independently writeable sector stores primarily video material;
at least one independently writeable sector stores primarily audio material; and at least one independently writeable sector stores metadata associated with the audio and/or video material, the metadata including at least a material identifier and other data relating to the material.

12. A method of editing a tape medium according to claim 9, the method comprising the steps of reading, modifying and rewriting metadata stored in the metadata sector(s) of the slant tracks independently of the audio and video material stored in the audio and video sectors of the slant tracks.

13. A video recorder operable to record video and audio material together with a timecode having a plurality of user-definable data bits;
the video recorder being operable to store a material identifying code in a subset of the user-definable bits of the timecode so that each instance of the material identifying code extends over the timecode user bits corresponding to an ordered sequence of more than one frame of the video material, the recorder also recording in a further subset of the user-definable bits of the timecode for each frame a sequence position indicator, indicative of the position of the current frame in the ordered sequence.

14. A video recorder according to claim 13, the recorder being a tape recorder operable to record video and audio material in successive slant tracks and at least one linear track on a tape medium, the linear track storing a linear track timecode having a plurality of user-definable data bits.

15. A video recorder according to claim 14, in which the material identifying code and the sequence position indicator are stored in respective subsets of the user-definable bits of the linear track timecode.

16. A video recorder according to any one of claims 13 to 15, in which the material identifying code is a code which uniquely defines the material amongst other material items stored on the same medium.

17. A video recorder according to claim 16, in which the material identifying code is an SMPTE UMID.

18. A recording medium format for recording video and audio material together with a timecode having a plurality of user-definable data bits; a subset of the user-definable data bits of the timecode storing a material identifying code so that each instance of the material identifying code extends over the timecode user bits corresponding to an ordered sequence of more than one frame of the video material, a further subset of the user-definable bits of the timecode for each frame storing a sequence position indicator, indicative of the position of the current frame in the ordered sequence.

19. A recording medium having recorded thereon video and audio material together with a timecode having a plurality of user-definable data bits; a subset of the user-definable data bits of the timecode storing a material identifying code so that each instance of the material identifying code extends over the timecode user bits corresponding to an ordered sequence of more than one frame of the video material, a further subset of the user-definable bits of the timecode for each frame storing a sequence position indicator, indicative of the position of the current frame in the ordered sequence.

20. A video recording method in which video and audio material together with a timecode having a plurality of user-definable data bits are recorded on a recording medium; the method comprising the steps of:
recording a material identifying code in a subset of the user-definable bits of the timecode so that each instance of the material identifying code extends over the timecode user bits corresponding to an ordered sequence of more than one frame of the video material; and recording in a further subset of the user-definable bits of the timecode for each frame a sequence position indicator, indicative of the position of the current frame in the ordered sequence.

21. A tape recorder substantially as hereinbefore described with reference to the accompanying drawings.

22. A tape format substantially as hereinbefore described with reference to the accompanying drawings.

23. A recording medium substantially as hereinbefore described with reference to the accompanying drawings.

24. A recording method substantially as hereinbefore described with reference to the accompanying drawings.

25. Editing apparatus substantially as hereinbefore described with reference to the accompanying drawings.

26. An editing method substantially as hereinbefore described with reference to the accompanying drawings.

27. A video recorder substantially as hereinbefore described with reference to the accompanying drawings.

28. Computer software for carrying out a method according to any one of claims 11, 12, 20, 24 or 26.

29. A providing medium by which software according to claim 28 is provided.

30. A medium according to claim 29, the medium being a storage medium.

31. A medium according to claim 29, the medium being a transmission medium.
